(19) United States
(12) Patent Application Publication
(10) Pub. No.: US 2023/0191335 A1
(43) Pub. Date: Jun. 22, 2023

(54) A SEMI-CRYSTALLINE POLYMER MEMBRANE

(71) Applicant: NATIONAL UNIVERSITY OF SINGAPORE, Singapore (SG)

(72) Inventors: Kangjia LU, Singapore (SG); Tai-Shung Neal CHUNG, Singapore (SG)

(21) Appl. No.: 17/924,297

(22) PCT Filed: May 12, 2021
(86) PCT No.: PCT/SG2021/050262

§ 371 Date: Nov. 9, 2022

(30) Foreign Application Priority Data
May 13, 2020 (SG) 10202004440U

(51) Int. Cl. B01D 67/00; B01D 69/02; B01D 69/06; B01D 71/34

(52) U.S. Cl. CPC B01D 67/0013; B01D 67/0095; B01D 69/02; B01D 69/06; B01D 71/34; B01D 2325/04; B01D 2325/06; B01D 2325/24; B01D 2325/36; B01D 2325/38

(57) ABSTRACT

There is provided a semi-crystalline polymer membrane, the membrane being a single-layer membrane and su-perwettable without provision of a coating or additives. There is also provided a method of forming the membrane comprising: depositing a solution on a substrate surface, the solution comprising a semi-crystalline polymer to form a nascent membrane; spraying a fluid on the nascent membrane; and immersing the nascent membrane in a non-solvent to form the semi-crystalline polymer membrane. In preferred embodiments, the fluid sprayed on the nascent membrane is selected from compressed air, water, a mixture of ethanol and water, or a solid suspension of ethanol/water/sodium chloride.

### TECHNICAL FIELD

The present invention relates to a porous semi-crystalline polymer membrane and a method of forming the same.

### BACKGROUND

Conventional fabrication technologies of superhydrophobic and self-cleaning membranes for wastewater treatment often involve complex surface modifications and massive usage of nanomaterials or organic solvents. For example, current methods involve the use of depositing nanomaterials such as TiO₂, SiO₂, ZnO nanoparticles or carbon nanotubes on polymeric substrates. However, other than being chemically invasive, grafting a uniform layer of nanomaterials is difficult, particularly when scaling up. Further, the risk of the nanomaterials leaching from the membrane surface is also a growing concern due to their potential toxicity to humans and the environment.

Other methods currently being used include nonsolvent induced phase separation (NIPS) and vapour induced phase separation (VIPS). However, the NIPS method involves the use of a large amount of organic solvents which increases the cost and carbon footprint, while the VIPS method requires prolonged exposure time which is not practical if the method is to be scaled up.

Thus, there is a need for an improved superwettable membrane and an improved method for forming the same.

### SUMMARY OF THE INVENTION

The present invention seeks to address these problems, and/or to provide an improved semi-crystalline polymer membrane.

According to a first aspect, the present invention provides a porous semi-crystalline polymer membrane, wherein the membrane is a single-layer membrane and wherein the membrane is superwettable without provision of a coating or additives.

According to one particular aspect, the membrane may be superhydrophobic. For example, the membrane may comprise, but is not limited to, poly(vinylidene fluoride) (PVDF), poly(vinylidene fluoride-co-hexafluoropropylene) (PVDF-HFP), polypropylene (PP), copolymers or homopolymers thereof.

According to another particular aspect, the membrane may be superhydrophilic. For example, the membrane may comprise, but is not limited to, polyacrylonitrile (PAN), cellulose acetate (CA), copolymers or homopolymers thereof.

The membrane may have a suitable porosity. For example, the membrane may have an overall porosity of ≥ 80%. For example, the surface of the membrane may have a porosity of ≥ 30%.

According to a particular aspect, the membrane may comprise multi-level roughness within a surface of the membrane. For example, the membrane may have a surface roughness of 150-900 nm.

The membrane may have a suitable thickness. For example, the thickness of the membrane may be about 50-250 µm.

The membrane may have suitable mechanical properties. According to a particular aspect, the membrane may have a Young’s modulus of ≥ 10 MPa.

The membrane may have a suitable liquid entry pressure (LEP) and a suitable water flux. For example, the membrane may have a LEP of ≥ 2 bar. The membrane may have a water flux of 10-40 kg/m².h.

The membrane may be for use in any suitable application such as wastewater treatment.

The membrane may be formed by any suitable method. For example, the membrane may be formed by the method according to the second aspect of the present invention.

According to a second aspect, there is provided a method of forming a porous semi-crystalline polymer membrane, the method comprising:
depositing a solution on a substrate surface, wherein the solution comprises a semi-crystalline polymer to form a nascent membrane;
spraying a fluid on the nascent membrane; and
immersing the nascent membrane in a non-solvent to form the semi-crystalline polymer membrane,
wherein the semi-crystalline polymer membrane is a single-layer membrane and superwettable without provision of a coating and additives.

The depositing may be by any suitable method. For example, the depositing may comprise, but is not limited to, casting, dip coating, spin coating, or a combination thereof.

The semi-crystalline polymer may be any suitable polymer. For example, the semi-crystalline polymer may be a hydrophobic or hydrophilic polymer. When the semi-crystalline polymer comprises a hydrophobic polymer, the membrane formed may be superhydrophobic. In particular, the hydrophobic polymer may be, but not limited to, poly(vinylidene fluoride) (PVDF), poly(vinylidene fluoride-co-hexafluoropropylene) (PVDF-HFP), polypropylene (PP), copolymers or homopolymers thereof.

When the semi-crystalline polymer comprises a hydrophilic polymer, the membrane formed may be superhydrophilic. In particular, the hydrophilic polymer may be, but not limited to, polyacrylonitrile (PAN), cellulose acetate (CA), copolymers or homopolymers thereof.

The solution may further comprise a solvent and a non-solvent. For example, the solvent and the non-solvent may be any suitable solvent and non-solvent, respectively.

The depositing may be under suitable conditions. For example, the depositing may comprise depositing the solution at a pre-determined temperature and pre-determined relative humidity. For example, the pre-determined temperature may be 20-60° C. For example, the pre-determined relative humidity may be ≥ 40%.

The fluid may be any suitable fluid. For example, the fluid may be, but not limited to, compressed air, alcohol, water, salt suspension, or a combination thereof. The alcohol may comprise any suitable alcohol. For example, the alcohol may be, but not limited to, ethanol, isopropanol, butanol, or a combination thereof.

The spraying may comprise spraying under suitable conditions. For example, the spraying may comprise spraying the fluid on the nascent membrane at a pre-determined pressure and at a pre-determined flow rate. For example, the pre-determined pressure may be 1-3 bar. For example, the pre-determined flow rate may be 15-30 L/minute.

The method may further comprise drying the membrane following the immersing. The drying may be by any suitable method.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings. In the drawings:

FIG. 1 shows a schematic representation of a setup for measuring liquid entry pressure (LEP) values of membranes;

FIG. 2 shows the water contact and sliding angles on different membranes;

FIG. 3 shows the Field Emission Scanning Electron Microscope (FE-SEM) images of the surface morphologies and topologies of (a) NIPS; (b) SANIPS-A (c) SANIPS-E; and (d) SANIPS-W membranes, respectively;

FIG. 4 shows the FE-SEM images of the membrane cross-sectional structures of (a) NIPS; (b) SANIPS-A; (c) SANIPS-E; and (d) SANIPS-W membranes, respectively, in which A, E and W represent air, ethanol and water, respectively;

FIG. 5 shows the mass changes of NIPS and SANIPS-A nascent membranes in air;

FIG. 6 shows the FE-SEM images of top surfaces of VIPS membranes with exposure time in air (relatively humidity of 60%) for (a) 5 minutes; (b) 15 minutes; and (c) 30 minutes.

FIG. 7 shows a schematic of the proposed mechanism of the spray-assisted non-solvent induced phase separation (SANIPS) process;

FIG. 8 shows the roughness of the top surfaces of the SANIPS-A, SANIPS-E, and SANIPS-W membranes;

FIG. 9 shows the porosity and thickness of the SANIPS-A, SANIPS-E, and SANIPS-W membranes;

FIG. 10 shows the tensile stress and Young’s modulus of the SANIPS-A, SANIPS-E, and SANIPS-W membranes;

FIG. 11 shows the liquid entry pressure of the SANIPS-A, SANIPS-E, and SANIPS-W membranes;

FIG. 12(a) shows the short-term DCMD fluxes of NIPS and SANIPS membranes;

FIG. 12(b) shows the long-term DCMD performances of SANIPS-LE and SANIPS-LW;

FIG. 13 shows the FE-SEM images of (a) top surface of NIPS after 5 hours DCMD test; (b) top surface of SANIPS-W after 5 hours DCMD test; (c) top surface of SANIPS-LE (inset shows a water droplet on SANIPS-LE with contact angle of 153.52 ± 0.56°); (d) cross-section of SANIPS-LE; (e) top surface of SANIPS-LW (inset shows a water droplet on SANIPS-LW with contact angle of 150.14 ± 0.37°); and (f) cross-section of SANIPS-LE membranes, respectively;

FIG. 14 shows the FE-SEM images of top surfaces and cross sections of (a) PVDF-HFP; and (b) PAN membranes, prepared via NIPS, and SANIPS with air spraying and water spraying;

FIG. 15(a) shows the contact and sliding angles of PVDF-HFP membranes; FIG. 15(b) shows the contact angles of PAN membranes;

FIG. 16 shows the FE-SEM images of a membrane prepared by spraying a mixture of ethanol/water: 50/50 by weight;

FIG. 17 shows the FE-SEM images of a membrane prepared by spraying a mixture of ethanol/water/NaCl: 50/36.8/13.2 by weight;

FIG. 18 shows the FE-SEM images of air-sprayed membranes with different spraying durations; images A1-A6 are top surfaces; images B1-B6 are enlarged top surfaces; image C1-C6 are cross-sectional images; images D1-D6 are enlarged center parts of the cross sections; 1 denotes the control NIPS membrane; and 2-6 represent spraying durations from 30 to 90 seconds with a 15-second interval;

FIG. 19 shows the contact angles and sliding angles of membranes with varying spraying durations;

FIG. 20 shows mechanical properties (tensile strain, Young’s modulus, and tensile strength) of air-sprayed membranes (dope temperature: 60° C., ambient temperature: 25° C., ambient humidity: 50%) prepared using different spraying durations;

FIG. 21 shows the FE-SEM images of the membrane made under optimal casting conditions (a) the top surface; (b) the top surface, magnified; (c) the cross-section; (d) the cross-section, magnified;

FIG. 22 shows the liquid entry pressure and burst pressure values of the control non-solvent induced phase separation (NIPS) membrane and SANIP membrane prepared with 60 seconds of air spraying; and

FIG. 23 shows the long-term DCMD performance test results of the SANIP membrane prepared with 60 seconds of air spraying.

### DETAILED DESCRIPTION

As explained above, there is a need for an improved membrane which is superwettable as well as a method of forming the same.

In general terms, the present invention provides a superwettable and self-cleaning porous membrane. The membrane of the present invention has a suitably high water flux and salt rejection, making it suitable for use in wastewater treatments such as recycling high salinity wastewater. The membrane may also exhibit resistance to wetting, fouling and scaling due to its hierarchical structure and self-cleaning properties. Further, the method for forming the membrane does not require heavy use of organic solvents, the method is a safe, low-cost and environmentally friendly method with minimal organic waste being generated. Further, the method minimises or avoids any post-treatment of the formed membrane.

According to a first aspect, the present invention provides a porous semi-crystalline polymer membrane, wherein the membrane is a single-layer membrane and wherein the membrane is superwettable without provision of a coating or additives. In other words, there is no post-treatment surface modification of the membrane to confer its superwettable characteristics.

For the purposes of the present invention, a semi-crystalline polymer may be defined as a polymer which comprises both crystalline and amorphous regions. In particular, the polymer may have a highly ordered molecular structure exhibiting organised and tightly packed molecular chains.

As mentioned above, the membrane according to the present invention shows superwettability. For the purposes of the present invention, superwettability refers to a state that is either superhydrophobic or superhydrophilic.

According to one particular aspect, the membrane may be superhydrophobic. In particular, the membrane surface may be highly hydrophobic and may have a contact angle ≥ 150° in air. Accordingly, the membrane may comprise a semi-crystalline polymer which may be hydrophobic. The hydrophobic semi-crystalline polymer may be any suitable polymer. For example, semi-crystalline polymer may comprise, but is not limited to, poly(vinylidene fluoride) (PVDF), poly(vinylidene fluoride-co-hexafluoropropylene) (PVDF-HFP), polypropylene (PP), copolymers or homopolymers thereof.

According to another particular aspect, the membrane may be superhydrophilic. In particular, the membrane surface may be highly hydrophilic and may have a contact angle of 0° in air. Accordingly, the membrane may comprise a semi-crystalline polymer which may be hydrophilic. The hydrophilic semi-crystalline polymer may be any suitable polymer. For example, semi-crystalline polymer may comprise, but is not limited to, polyacrylonitrile (PAN), cellulose acetate (CA), copolymers or homopolymers thereof.

The membrane may be a hierarchical membrane in that the membrane may comprise multi-level roughness within the membrane. For the purposes of the present invention, reference to multi-level roughness refers to the membrane comprising a varying surface roughness across different parts of the membrane. In particular, the top surface of the membrane may comprise multi-level roughness. For the purposes of the present invention, the top surface is defined as the surface of the membrane facing air during casting. The top surface of the membrane may have a surface roughness of 150-900 nm. In particular, the surface roughness may be 200-850 nm, 250-800 nm, 300-750 nm, 350-700 nm, 400-650 nm, 450-600 nm, 500-550 nm.

Further, the membrane may comprise a highly porous top surface. In particular, the surface of the membrane may have a porosity of ≥ 30%. For example, the top surface may have a porosity of 30-95%, 35-90%, 40-85%, 45-80%, 50-75%, 55-70%, 60-70%. Even more in particular, the top surface of the membrane may have a porosity of 30-55%.

The membrane may have a suitable overall porosity. For the purposes of the present invention, overall porosity refers to the average porosity of the entire membrane. For example, the membrane may have an overall porosity of ≥ 80%. In particular, the overall porosity of the membrane may be 80-95%, 82-92%, 85-90%, 86-88%.

The membrane may have a suitable cross-sectional structure. In particular, the cross-sectional structure of the membrane may be macrovoid-free. In this way, the membrane has structural integrity as presence of macrovoids would result in mechanically weak points

The membrane may have a suitable thickness. For example, the thickness of the membrane may be about 50-250 µm. In particular, the thickness of the membrane may be 55-200 µm, 60-190 µm, 70-175 µm, 80-150 µm, 85-130 µm, 90-125 µm, 100-110 µm. Even more in particular, the thickness may be 70-90 µm.

The membrane may have suitable mechanical properties. According to a particular aspect, the membrane may have a Young’s modulus of ≥ 10 MPa. In particular, the membrane may have a Young’s modulus of 10-91 MPa, 15-80 MPa, 20-75 MPa, 25-70 MPa, 30-65 MPa, 35-60 MPa, 40-55 MPa, 45-50 MPa. Even more in particular, the Young’s modulus may be 80-90 MPa.

The membrane may have a suitable tensile stress. For example, the membrane may have a tensile stress of 0.3-4.0 MPa. In particular, the tensile stress may be 0.3-3.7 MPa, 0.45-3.5 MPa, 0.5-3.0 MPa, 1.0-2.5 MPa, 1.5-2.0 MPa.

The mechanical properties of the membrane may be further improved by casting the membrane on a non-woven support. The non-woven support may be any suitable non-woven support.

The membrane may have a suitable liquid entry pressure (LEP) and a suitable water flux. The LEP may be defined as the applied hydraulic pressure at which water can penetrate through the membrane. According to a particular aspect, the membrane may have a LEP of ≥ 0.75 bar. In particular, the LEP may be ≥ 2.0 bar. For example, the LEP may be 0.75-4 bar, 0.8-3.5 bar, 1.0-3.2 bar, 1.5-3.0 bar, 2.0-2.5 bar. Even more in particular, the LEP may be 3-4 bar.

The membrane may have a water flux of 10-40 kg/m².h. According to a particular aspect, the membrane may have a water flux of 15-40 kg/m².h. For example, the membrane may have a water flux of 17-38 kg/ m².h, 20-35 kg/ m².h, 25-30 kg/ m².h. Even more in particular, the water flux may be 25-36 kg /m².h.

The membrane may be for use in any suitable application. For example, the membrane may be for use in, but not limited to, wastewater treatment, desalination, processes, oil/water separation, gas absorption.

The membrane may be formed by any suitable method. For example, the membrane may be formed by a method according to the second aspect of the present invention.

According to a second aspect, there is provided a method of forming a porous semi-crystalline polymer membrane, the method comprising:
depositing a solution on a substrate surface, wherein the solution comprises a semi-crystalline polymer to form a nascent membrane;
spraying a fluid on the nascent membrane; and
immersing the nascent membrane in a non-solvent to form the semi-crystalline polymer membrane,
wherein the semi-crystalline polymer membrane is a single-layer membrane and superwettable without provision of a coating and additives.

In particular, the method may be considered to be a spray-assisted non-solvent induced phase separation (SANIPS) method.

The membrane formed by the method may be as described above in relation to the first aspect.

The solution may be prepared by any suitable method. For example, solution may be prepared by mixing the semi-crystalline polymer in a solvent and a non-solvent.

The semi-crystalline polymer may be any suitable polymer. For example, the semi-crystalline polymer may be as described above. In particular, the semi-crystalline polymer may be a hydrophobic or hydrophilic polymer. When the semi-crystalline polymer comprises a hydrophobic polymer, the membrane formed may be superhydrophobic. The hydrophobic polymer may be, but not limited to, poly(vinylidene fluoride) (PVDF), poly(vinylidene fluoride-co-hexafluoropropylene) (PVDF-HFP), polypropylene (PP), copolymers or homopolymers thereof.

When the semi-crystalline polymer comprises a hydrophilic polymer, the membrane formed may be superhydrophilic. In particular, the hydrophilic polymer may be, but not limited to, polyacrylonitrile (PAN), cellulose acetate (CA), copolymers or homopolymers thereof.

The solvent may be any suitable solvent. For example, the solvent may be, but not limited to, N-methyl-2-pyrrolidone (NMP), dimethylformamide (DMF), dimethylacetamide (DMAC), or a mixture thereof. In particular, the solvent may be NMP.

The non-solvent may be any suitable non-solvent. For example, the non-solvent may be a short chain alcohol. A short chain alcohol may be defined as an alcohol which comprises less than 12 carbon atoms. In particular, the non-solvent may be, but not limited to, ethylene glycol (EG), water, polyethylene glycol (PEG), or a mixture thereof. Even more in particular, the non-solvent may be EG.

The solution may comprise a suitable amount of semi-crystalline polymer. For example, the solution may comprise 8-15 wt% semi-crystalline polymer based on the total weight of the solution.

The solution may further comprise additives. The additives may be any suitable additives.

According to a particular aspect, the depositing may be by any suitable method. For example, the depositing may comprise, but is not limited to, casting, dip coating, spin coating, or a combination thereof. In particular, the depositing may comprise casting.

The depositing may be under suitable conditions. For example, the depositing may comprise depositing the solution at a pre-determined temperature and pre-determined relative humidity. The pre-determined temperature may be any suitable temperature. For example, the pre-determined temperature may be 20-60° C. According to a particular aspect, the pre-determined temperature may be 20-35° C. In particular, the temperature may be 22-55° C., 25-50° C., 28-45° C., 30-40° C., 32-38° C., 33-35° C. Even more in particular, the temperature may be about 25° C.

The pre-determined relative humidity may be any suitable relative humidity. For example, the pre-determined relative humidity may be ≥ 40%. In particular, the relative humidity may be 40-80%, 45-75%, 50-70%, 55-65%, 58-60%. Even more in particular, the relative humidity may be about 50%.

The fluid used in the spraying may be any suitable fluid. The fluid may also comprise solid suspension. For example, the fluid may be, but not limited to, compressed air, alcohol, water, salt suspension, or a combination thereof. According to a particular aspect, the alcohol may comprise a mixture of one or more alcohols and/or aqueous solutions comprising one or more alcohol. The alcohol may comprise any suitable alcohol. For example, the alcohol may be, but not limited to, ethanol, isopropanol, butanol, or a mixture thereof.

The spraying may comprise spraying under suitable conditions. For example, the spraying may comprise spraying the fluid on the nascent membrane at a pre-determined pressure, at a pre-determined flow rate and at a pre-determined period of time.

The pre-determined pressure may be any suitable pressure. For example, the pre-determined pressure may be 1-3 bar. In particular, the pre-determined pressure may be 1.2-2.8 bar, 1.5-2.5 bar, 2-2.2 bar. Even more in particular, the pre-determined pressure may be 2 bar.

The pre-determined fluid flow rate may be any suitable flow rate. For example, the pre-determined flow rate may be 15-30 L/minute. In particular, the pre-determined flow rate may be 18-28 L/minute, 20-25 L/minute, 22-24 L/minute. Even more in particular, the pre-determined flow rate may be 20-23 L/minute.

The pre-determined period of time for the spraying may be any suitable period of time. For example, the pre-determined period of time may be 30-120 seconds. In particular, the pre-determined period of time may be 45-100 seconds, 50-90 seconds, 55-80 seconds, 60-75 seconds, 65-70 seconds. Even more in particular, the pre-determined period of time may be about 60-90 seconds.

The immersing may be under suitable conditions. According to a particular aspect, the immersing may be for a pre-determined period of time. The pre-determined period of time may be any suitable period of time, particularly a period of time suitable for completing phase inversion. For example, the pre-determined period of time may be 5-48 hours. In particular, the pre-determined period of time may be 8-40 hours, 10-35 hours, 12-30 hours, 15-28 hours, 18-24 hours, 20-22 hours. According to a particular aspect, the pre-determined period of time may be 10-20 hours. Even more in particular, the pre-determined period of time may be about 20 hours.

The non-solvent used in the immersing may be any suitable non-solvent. The non-solvent may be the same or different from the non-solvent comprised in the solution comprising a semi-crystalline polymer described above. For example, the non-solvent may be, but not limited to, water, alcohols, or a mixture thereof. In particular, the non-solvent may be water.

The method may further comprise drying the membrane following the immersing. The drying may be by any suitable method. In particular, the drying may comprise freeze drying or solvent exchange method.

As can be seen form the above, the method of the present invention provides a simple and cost-effective way of preparing semi-crystalline porous membranes which are also superwettable without requiring any post-treatments such as coatings to provide the superwettable properties. Further, the phase inversion rate in the method may be modulated by applying spraying fluids with various physiochemical properties and the physical impact of the compressed flow of the spraying fluids cause local distortion of the membrane structure, thereby introducing an extra level of roughness.

Having now generally described the invention, the same will be more readily understood through reference to the following example which is provided by way of illustration, and is not intended to be limiting.

### EXAMPLES

### Materials

Commercial poly(vinylidene fluoride) (PVDF) homopolymer (Kynar® HSV 900) and poly(vinylidene fluoride)-co-hexafluoropropylene (PVDF-HFP) copolymer (Kynar Flex® 2801) were obtained from Arkema Inc. Polyacrylonitrile (PAN) (Mw = 200,000 g/mol) was obtained from Dolan GmbH. N-methyl-2-pyrrolidone (NMP, >99.5%), ethylene glycol (EG, >99.5%), and sodium chloride (NaCl, 99.5%) were purchased from Merck. Ethanol (>99.98%) was obtained from VWR. Rose bengal, methylene blue, and methyl orange were all obtained from Sigma Aldrich. Graphene oxide (GO) solution (5 mg/mL) was purchased from Angstron Materials Inc. Sodium dodecyl sulfate (SDS) was obtained from Thermofischer Scientific. All the aforementioned chemicals were used as received. De-ionized (DI) water used in this work was produced by an Elga Option R7 unit.

### Example 1 - PVDF Membranes

### Preparation of Membranes

PVDF (HSV 900), NMP (solvent) and EG (non-solvent) were added into a round-bottom flask and agitated at 60° C. overnight to obtain a transparent polymer blend. Polymer solutions were then settled at 60° C. for 12 hours to get rid of air bubbles.

Flat sheet polymer membranes were prepared via spray-assisted non-solvent induced phase separation (SANIPS) as follows. First, the polymer solution was cast on a glass plate by a casting knife with a height of 200 µm. Subsequently, compressed air or a designated solution (~1 mL) was sprayed uniformly on the entire nascent membrane using an airbrush with a nozzle size of 0.3 mm for 30 seconds. The air gun was moved over the glass plate at a constant speed of 5 cm/s to ensure uniform spraying. The airbrush was connected to a mini air compressor (HSENG AF18-2), which provided an average working pressure of 2 bar and an air flow rate of 20-23 L/min. The temperature and relative humidity of the casting environment were 25° C. and 60%, respectively. Next, the membrane was immersed and kept in DI water for 20 hours to complete the phase inversion and then dried in a freeze dryer (S61-Modulyo-D, Thermo Electron Corp.) for future use. These membranes are referred to as SAPS PVDF membranes, and named SANIPS-A, SANIPS-E, and SANIPS-W, corresponding to air, ethanol and water as the spraying materials, respectively.

Control membranes were prepared via Non-solvent Induced Phase Separation Process (NIPS) where the newly cast membrane was directly immersed in the coagulation bath of DI water for phase inversion. To prepare Vapour Induced Phase Separation Process (VIPS) membranes, the membranes were placed in air (relative humidity: 60%) for designated durations of 5-30 minutes before they were immersed and kept in water.

Dope compositions and fabrication conditions of SANIPS, NIPS, and VIPS membranes are shown in Tables 1 and 2.

TABLE 1

Dope compositions and membrane preparation condition

| Parameter | NIPS | SANIPS-A | SANIPS-E | SANIPS-W | SANIPS-LE | SANIPS-W |
|---|---|---|---|---|---|---|
| Dope concentration (wt. %) | PVDF (HSV900)/EG/NMP=15/10/75 | | | | PVDF (HSV900)/EG/NMP=12/ 10/78 | |
| Dope temperature (°C) | 60.0±0.5 | | | | | |
| Relative humidity (%) | 60.0±2.5 | | | | | |
| Spray material | - | Compressed air | Ethanol | Water | Ethanol | Water |
| Duration in water (h) | 20 | | | | | |

TABLE 2

Dope compositions and fabrication conditions for membranes prepared via VIPS method

| Parameter | VIPS - 5 min | VIPS -15 min | VIPS - 30 min |
|---|---|---|---|
| Dope concentration (wt. %) | PVDF/EG/NMP=15/10/75 | | |
| Dope temperature (°C) | 60.0±0.5 | | |
| Relative humidity (%) | 60 | | |
| Spray material | 5 | 15 | 30 |
| Duration in water (h) | 20 | | |

### Characterization of Membranes

### Surface Morphology

Membrane morphology was observed by a field-emission scanning electron microscope (FE-SEM JEOL JSM-7610F). To observe the cross-sectional structure, the sample was prepared by fracturing the membrane in liquid nitrogen. To monitor the degree of phase inversion in air, images of nascent membranes in air were taken before they were transferred to the water bath. Moreover, high-contrast microscopic images of nascent membrane surfaces in air were obtained by a polarized light microscopy (PLM, Olympus SZX16 Stereomicroscope). The SANIPS membrane samples were firstly prepared by levelling a dope solution of 2 g on a glass slide (4.63 ± 0.01 g, 25 mm × 75 mm) using a blade, then air, ethanol, or water were sprayed on top of the sample surfaces for 2 seconds. PLM images were processed by ImageJ software (NIH) to remove the background and to further enhance the contrast.

### Normalised Mass Change

The masses of small NIPS and SANIPS-A samples were monitored for 120 seconds by an accurate balance (A&D, GR-200). 2 g of dope solution was levelled on a glass slide (4.63 ± 0.01 g, 25 mm × 75 mm) using a blade. Due to the viscous nature of the polymer solution, a small amount of it may adhere to the blade. Therefore, instead of taking 6.63 g as the initial mass value, we recorded the actual total mass of the dope film and the glass as the initial mass value. The initial value of SANIPS-A was taken before the air spraying. During the 2 seconds of air spraying, no mass value was taken because the pressure of the compressed air may affect the balance reading. The second mass value was taken immediately after the spraying treatment. Subsequently, the mass of the sample was continuously recorded. Mass changes of different samples were normalized by the actual initial net mass of the polymer solution as described in equation (1):

$$\overline{Δ m} \% = \left(\frac{{m}_{t} - {m}_{i}}{{m}_{i} - {m}_{g}}\right) \times 100 \%$$

where mᵢ (kg) and mₜ (kg) were the sample masses at time zero and time t, respectively, and m_{g} (kg) was the mass of glass slide.

### Surface Topology and Roughness

Surface topology was analyzed by Nanoscope III atomic force microscopy (AFM) (Digital Instruments Inc.) with a tapping mode (Acoustic AC). To capture the roughness on both nanoscale and microscale, each sample was scanned with two scan sizes, namely, 10 µm × 10 µm, and 60 µm × 60 µm. Since the obtained mean roughness (Ra) and root mean square roughness (Rq) have the same trends, only Ra was reported to avoid redundancy.

### Membrane Porosity

Membrane porosity was calculated based on the following equation:

$$\text{ε=} \left(1 - \frac{{m}_{p}}{{ρ}_{p} A σ}\right) \times 100$$

where mₚ (kg) was the mass of the polymer. Since the mass of air was negligible, mₚ could be approximated by the mass of the dry membrane. A (m²) and σ (m) were the effective area and the average thickness of the membrane. ρₚ was the density of the PVDF polymer.

The surface porosity and pore size were obtained by analyzing FE-SEM images of the membrane surfaces via ImageJ software (NIH).

### Mechanical Properties

Mechanical properties of membranes were analyzed by an Instron tensiometer (Model 3342, Instron Corp.). The starting gauge length, membrane width and elongation rate were set as 50 mm, 5 mm, and 10 mm min⁻¹, respectively. Five samples were tested for each condition and the average was obtained.

### Contact and Sliding Angles

The dynamic water contact angles and sliding angles were measured with an optical contact angle measuring system (OCA25, Dataphysics) equipped with a tilting base unit. A DI water droplet with a volume of 6 µL was deposited on the membrane surface at a dispense rate of 2 µL/s. Contact angle was determined by the static sessile drop method with Young-Laplace equation as the fitting method. To measure the sliding angle, the platform was tilted at a rate of 1 degree per second. The titling angle at which the water droplet started to roll off was recorded as the sliding angle. All the measurements were conducted at room temperature (~25° C.) with a relative humidity of 60%. Five samples were tested for each condition.

### Liquid Entry Pressure

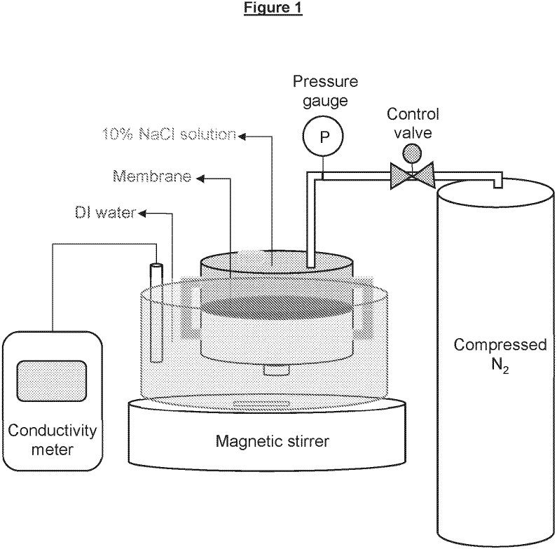

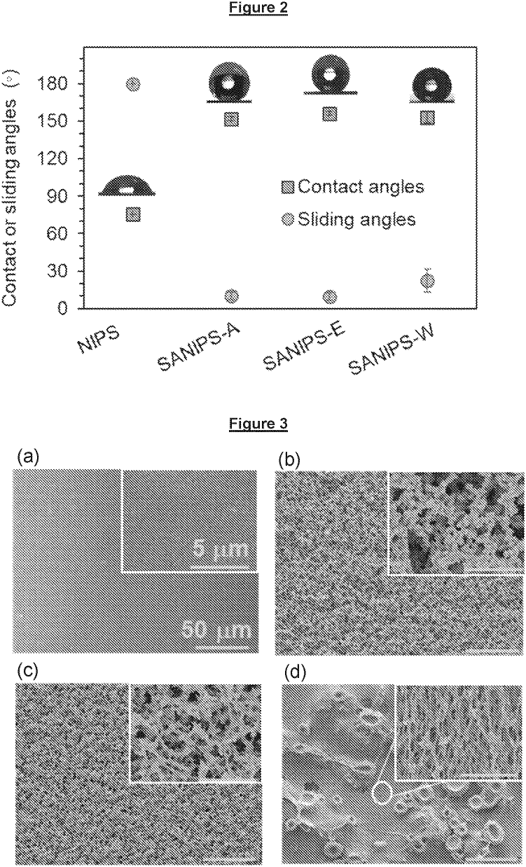

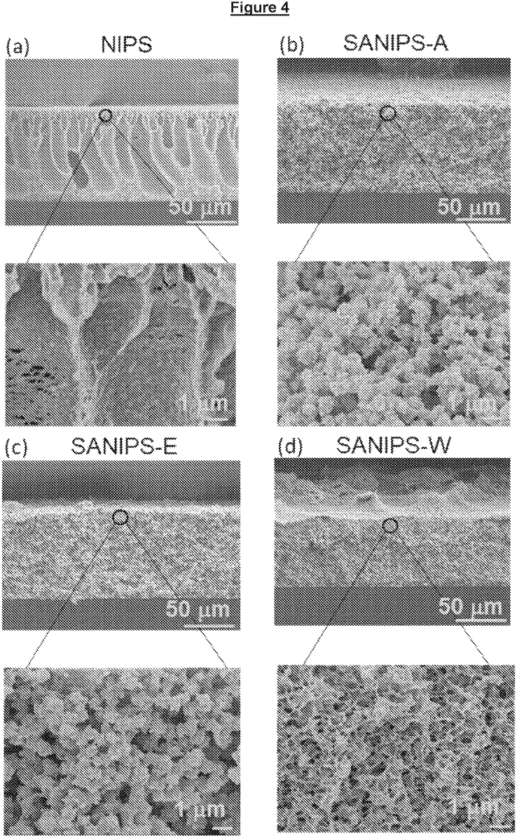

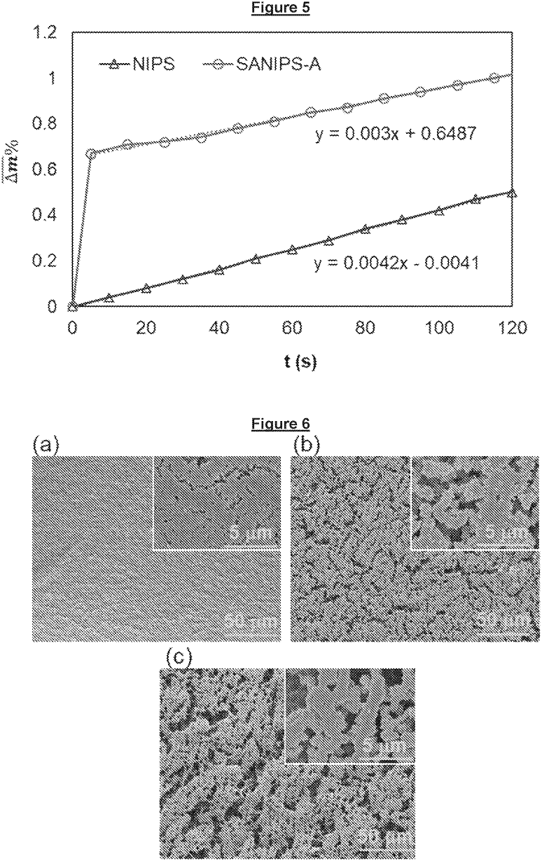

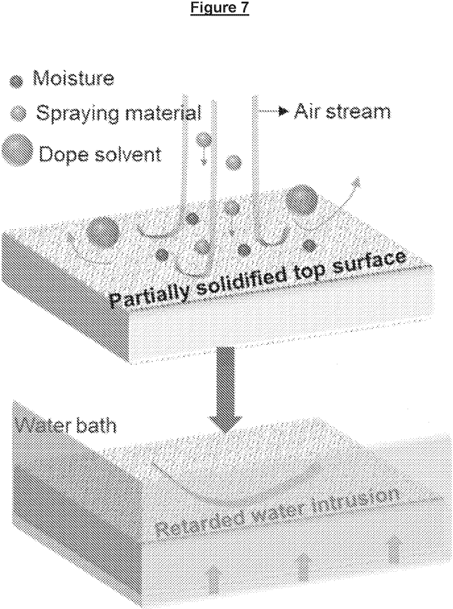

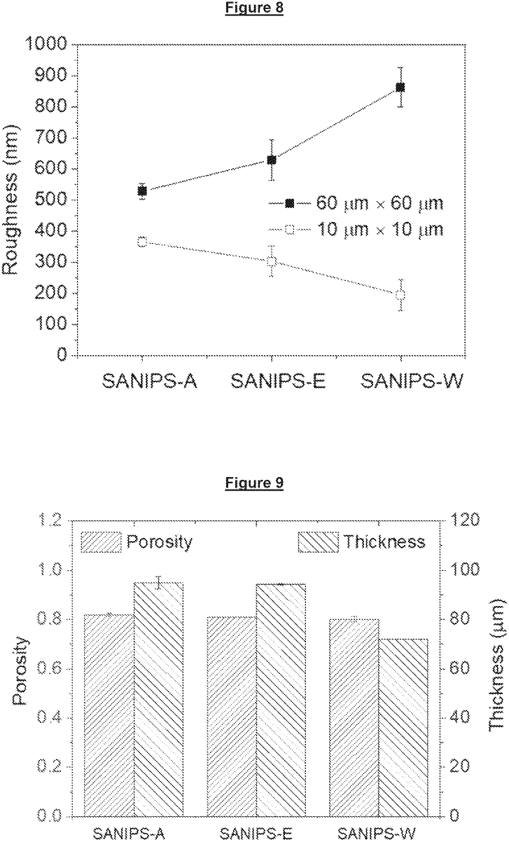

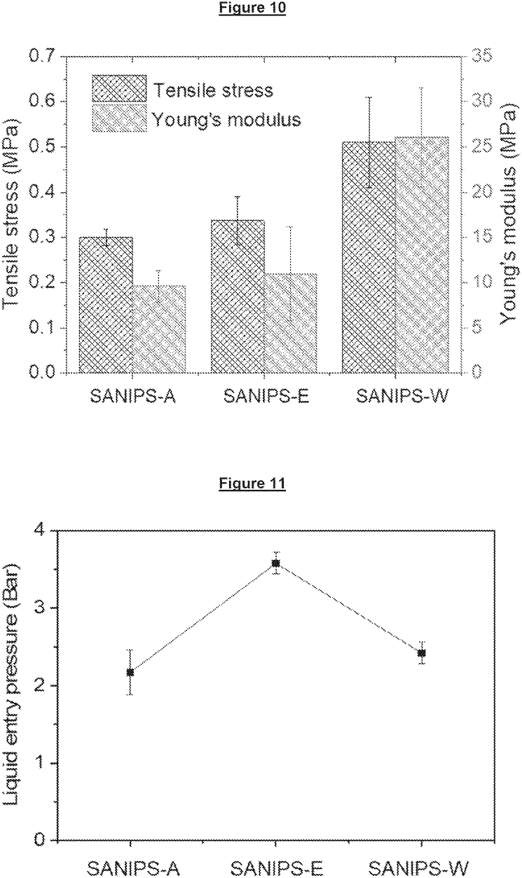

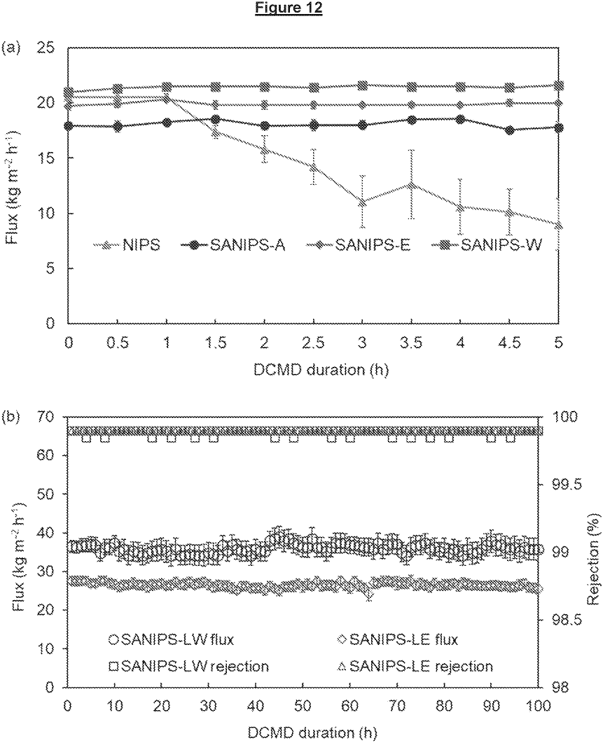

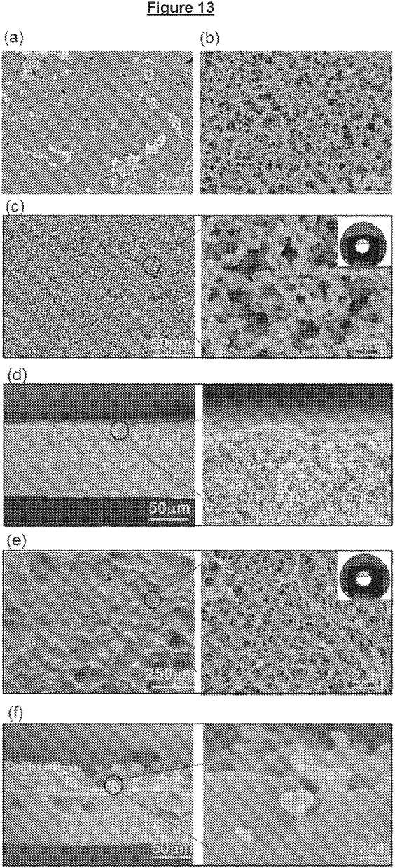

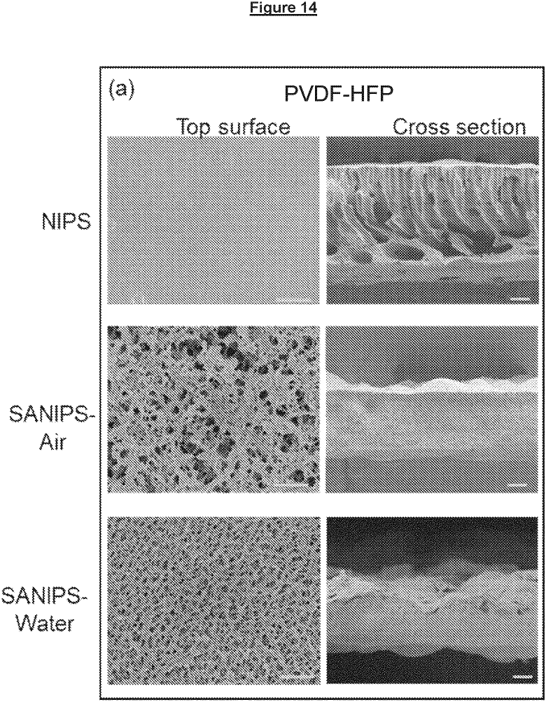

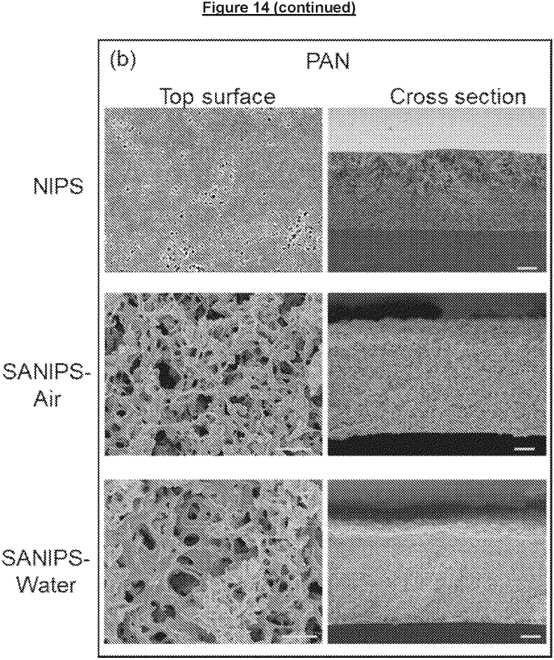

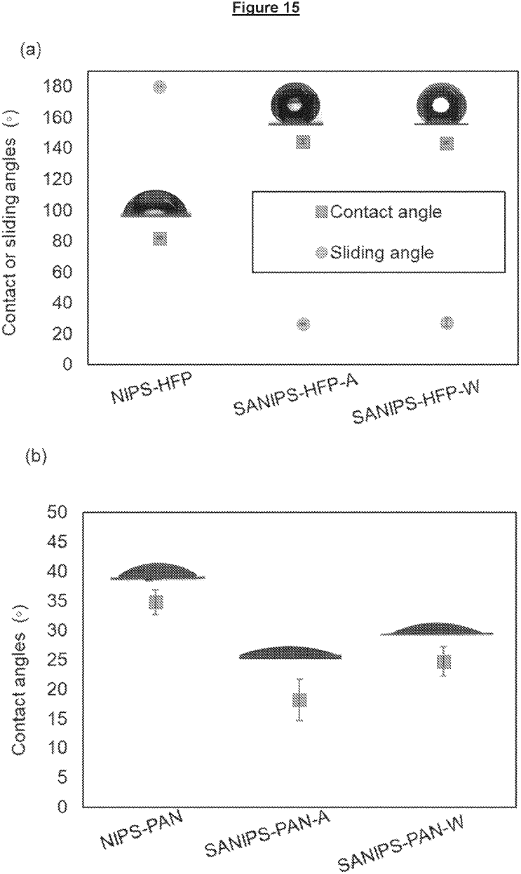

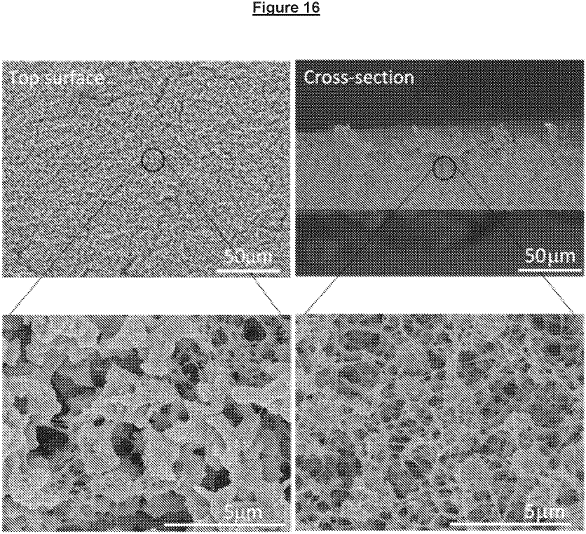

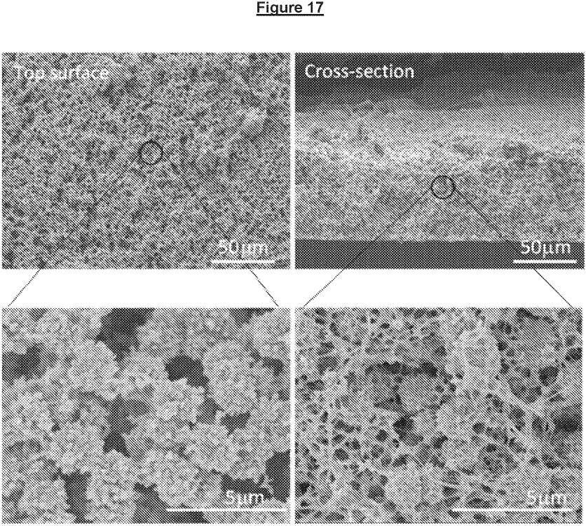

Liquid entry pressure (LEP) values of membranes were also measured using a setup as shown in FIG. 1. In an LEP test, a membrane size of 3 cm × 3 cm was mounted between two chambers which were then clamped tightly together. The top chamber was filled with a sodium chloride solution of 10%, while the bottom one was empty. Before the test, the top chamber was connected to compressed nitrogen, and then the entire testing unit was submerged in a DI water bath. During the test, the pressure in the top chamber was regularly increased at a rate of 0.25 bar per 10 minutes by a control valve, and the conductivity of the water bath was closely monitored. Once a constant increase in conductivity was observed, the pressure was recorded as the LEP. Three tests were conducted for each membrane.

### Direct Contact Membrane Distillation (DCMD) Tests

DCMD tests were performed on a lab scale setup. A membrane with an effective area of 2 cm² was assembled into a plastic module holder. During the test, a feed solution containing 10 wt. % NaCl and 2000 ppm Rose Bengal was contacting the superhydrophobic top surface of the membrane and it was circulated at a flow rate of 0.15 L/min. Cold DI water was circulated at 0.1 L/min on the other side to condense water vapor. The temperatures of feed and distillate were maintained at 60 ± 1.5° C. and 15 ± 1.8° C., respectively. The weight and conductivity of the distillate were continuously monitored. The flux (N_{w}) and rejection (β) of the membrane were calculated using equation (3) and equation (4), respectively.

$${N}_{w} = \frac{Δ W}{A t}$$

$$β = \left(1 - \frac{{C}_{p}}{{C}_{f}}\right) \times 100 \%$$

where ΔW (kg) was the mass change of the distillate over a time duration t (s). Cₚ and C_{f} (mol/L) were NaCl concentrations in the distillate and feed streams, respectively. Cₚ was calculated based on equation (5) by considering the dilution effect:

$${C}_{p} = \frac{{C}_{1} {m}_{1} - {C}_{0} {m}_{0}}{{m}_{1} - {m}_{0}}$$

where m₀ and m₁ were the initial and final masses of the distillate bath, respectively. C₀ and C₁, were the initial and final salt concentrations of the distillate stream, respectively, which could be calculated based on the conductivity.

Pictures of the membrane surfaces were taken after the DCMD tests. If the membrane is partially wet, dye molecules will penetrate membrane pores and change the colour of the membrane surface, which provides a qualitative way of observing the degree of surface wetting. However, for the NIPS membrane, the observation could be affected by the thin film of dye wastewater adhered to the membrane surface. Therefore, to supress the interference of the attached dye wastewater, the membrane was quickly rinsed in DI water for 1 second before a picture was taken. The same was applied to all the membranes for consistency.

### Results

### Superhydrophobic and Self-Cleaning Properties of Resultant Membranes

In contrast to the small water contact angle of the control NIPS membrane (75.8°), all the SANIPS membranes exhibit water contact angles over 150° (FIG. 2). Besides pure water, SANIPS membranes also showed great repellence toward various types of aqueous solutions, which contained 0.2 mM sodium dodecyl sulfate (SDS), 1% Rose bengal, 2000 ppm graphene oxide (GO), or 10% ethanol, indicating their potential for wide applications in the field of wastewater treatment.

On NIPS and SANIPS-A membranes tilted by 10°, the water droplet rapidly rolled off from SANIPS-A while it remained adhered to the NIPS membrane. The water droplet did not come off even when the NIPS membrane was turned upside down.

The self-cleaning properties of different membranes were assessed by immersing them in a Rose Bengal aqueous solution of 1 wt.%. The water surface was distorted downwards when SANIPS membranes were immersed in water, as a result of a strong water repellence of the superhydrophobic surface. When taken out from the dye solutions, all the SANIPS membranes remained unstained, which contrasted sharply with the control NIPS membrane.

### Surface Morphologies and Topologies

FIGS. 3(a) to 3(d) compare the surface morphologies and topologies of NIPS, SANIPS-A, SANIPS-E, and SANIPS-W membranes, respectively. In contrast to the smooth surface of the NIPS membrane, surfaces of all SANIPS membranes feature hierarchically structures and high surface porosities. The measurements of surface porosities and pore size are presented in Table 3.

TABLE 3

Surface porosity and surface pore sizes of NIPS and SANIPS membranes

| Membrane ID | NIPS | SANIPS-A | SANIPS-E | SANIPS-W |
|---|---|---|---|---|
| Surface porosity (%) | 5.6 ± 0.2 | 54.4 ± 0.1 | 47.6 ± 0.2 | 34.5 ± 0.1 |
| Mean pore size (nm) | 4.4 ± 0.1 | 227.3 ± 45.7 | 221.0 ± 22.5 | 168.4 ± 13.4 |
| Min pore size (nm) | 2.0 ± 0.0 | 30.3 ± 7.7 | 25.4 ± 5.2 | 21.3 ± 3.4 |
| Max pore size (nm) | 31.2 ± 0.7 | 6290.4 ± 206.8 | 4069.3 ± 126.5 | 1156.4 ± 58.7 |

A liquid droplet stays in a Cassie-Baxter state on a superhydrophobic surface, where the liquid is retained on the liquid-solid-vapour interface and wetting is prevented by air pockets trapped between the solid and liquid phases. High surface porosity and roughness are beneficial to achieve a large water contact angle. Consequently, the SANIPS membranes with a high surface roughness exhibit much superior water repellence as compared to the smooth NIPS membrane.

As seen from FIGS. 3(b) to 3(d), different spray materials resulted in distinct surface morphologies and topologies.

### Effects of Air Spray

As shown in FIGS. 3(a) and 4(a), the control NIPS membrane exhibited an asymmetric structure with a relatively smooth and dense top surface, and a cross-section with cellular structure and figure-like macrovoids, which can be ascribed to rapid liquid-liquid de-mixing using a strong non-solvent (i.e. water) as the coagulant medium. On the other hand, even though the SANIPS-A membrane was also subsequently precipitated in a water bath after the air spraying, it possessed a highly porous top surface with a multi-level roughness and a symmetrical macrovoid-free sponge-like cross section (FIGS. 3(b) and 4(b)). In general, macrovoids are undesirable as they are mechanically weak points that may facilitate pore wetting and lead to membrane failure in the long run.

To investigate the effects of air-spraying on membrane formation, a picture of the nascent membrane was taken immediately after it was treated by the compressed air and before being submerged in water, and compared with the newly cast control membrane. Air-spraying turned the original mirror-like surface with specular reflection to a frosted surface with diffuse reflection, indicating the occurrence of surface solidification. The nascent membrane samples were also observed using a polarized light microscope (PLM), which is a tool for monitoring phase inversion during the formation of polymeric membranes. The control membrane remained transparent in air, while the air-treated membrane showed micro-scale fine corrugations on the membrane surface, reaffirming that phase inversion occurred during the air spraying process.

The rapid phase inversion of SANIPS-A can be attributed to the combined effects of several factors. First, the compressed air flow causes convective cooling and accelerated the evaporation of the dope solvent (NMP) that induced a fast temperature drop at the membrane surface. Thus, the thermodynamic stability of the cast solution was impaired, which facilitated polymer nucleation and phase separation. In the meantime, moisture condensation was accelerated due to the rapid cooling, resulting in a fast phase inversion at the membrane surface.

Mass changes of NIPS and SANIPS-A nascent membranes in air were closely monitored and FIG. 5 shows the normalized results as a function of time. Mass of the control NIPS membrane increased at a relatively constant rate of around 0.0042% per second in the first 120 seconds due to the continuous absorption of moisture in air. In contrast, mass of SANIPS-A increased drastically by 0.67% immediately after the air spraying, which shows that moisture condensation is significantly accelerated. Interestingly, after the air spraying is terminated, the rate of mass increase of SANIPS-A quickly drops to 0.003% per second, even lower than that of NIPS. This can be ascribed to the partial solidification of the top surface that impedes the subsequent solvent evaporation and moisture diffusion.

On the other hand, the effect of air spraying is more than simply accelerating the phase inversion process. To elucidate this point, the SANIPS-A membranes were compared with membranes prepared via VIPS. In the VIPS method, the newly cast membrane was exposed to humid air for a fixed duration before being immersed in a coagulant bath, which allows a gradual phase inversion in air due to moisture condensation. Therefore, a partially solidified top surface can also be achieved by the VIPS method if the exposure time is long enough.

As shown in FIGS. 6(a) to 6(c), the membrane surface porosity increased rapidly as the exposure time extends. Hierarchical structures and superhydrophobicity cannot be achieved even with a prolonged exposure duration of 30 minutes. Therefore, it can be seen that the spraying process contributes more than simply expediting the phase inversion. The turbulent compressed air stream also causes local distortion of membrane surface, which played a critical role in the formation of hierarchical roughness.

After air spraying, the nascent membrane was transferred to a water coagulant bath to complete the phase inversion. Different from the NIPS method where solvent and non-solvent exchange rapidly at the membrane-water interface, the water in-flow and the NMP out-flow in the nascent SANIPS-A membrane was greatly hindered by the newly formed top skin. Thus, a delayed demixing occurs that allowed polymer crystals to grow and form a macrovoid-free cross-section structure full of spherulitic globules. The mechanism of the spray-assisted phase separation process is shown in FIG. 7.

### Effects of Different Spraying Materials

The effects of different spray materials on membrane formation were studied. Ethanol and water were selected because of their low costs and low toxicity. In addition, ethanol and water have different physicochemical properties as tabulated in Table 4 (Sukitpaneenit & Chung, 2009).

TABLE 4

Physicochemical properties of polymer, solvent and non-solvents

| Material | Total solubility parameter (MPa^{½}) | Specific gravity | Boiling point (°C) | Vapor pressure (mmHg at 20° C.) | Viscosity (10⁻³ Pa.s) | Surface tension (mN/m) | D°_{NS} ᵢₙ _{NMP}^{a} (10⁻⁶ cm² s⁻¹) |
|---|---|---|---|---|---|---|---|
| Poly(vinylidene fluoride) | 23.2 | 1.780 | - | - | - | - | - |
| N-Methyl-2-pyrrolidone | 22.9 | 1.026 | 202 | 0.24 | 1.65 | 41.26 | - |
| Ethanol | 26.5 | 0.789 | 78 | 43.89 | 1.22 | 21.97 | 10.5 |
| Water | 47.8 | 1.000 | 100 | 17.5 | 1 | 71.99 | 18.0 |

^{a} Diffusion coefficient of non-solvent in pure NMP

The surface of the membrane treated by ethanol spraying (SANIPS-E) had a uniform open structure and multi-level coralloidal morphology (FIGS. 3(c) and 4(c)). In contrast, the water treated membrane (SANIPS-W) revealed distinct volcano structures on its relatively less porous top surface (FIGS. 3(d) and 4(d)).

Topological images and roughness data (FIG. 8) showed an interesting phenomenon. With a large scan size of 60 µm × 60 µm, the roughness increased in the order of SANIPS-A < SANIPS-E < SANIPS-W, while this trend reversed on a smaller scan area of 10 µm × 10 µm. The former trend can be attributed to the formation of different micro-scale structures due to the bombardment of different droplets, while the latter may be attributed to the nano-scale transition from a spherulitic structure to a network structure.

The micro-scale structure of SANIPS-A was constituted by clusters of nanoscale polymer crystals. However, for SANIPS-E and SANIPS-W, the bombardment of liquid droplets caused the formation of large ridges separated by wide valleys, corresponding to higher roughness. At a smaller scan size, the instrument focussed on the nano-level structures and the valleys of SANIPS-E and SANIPS-W. The transition from the expanded spherulitic crystal structure to a flatter network structure corresponded to the decrease in roughness in the order of SANIPS-A > SANIPS-E > SANIPS-W.

As compared to air spraying, the introduction of liquid non-solvents as the spraying materials caused more rapid solvent-nonsolvent exchange, thus inducing faster phase inversion at dope-liquid contacting spots. The size of liquid droplets depended largely on the intermolecular attraction. Ethanol, which has a weak intermolecular force as indicated by its low surface tension of 21.97 mN/m at 25° C., can form a finer mist than water. A relatively uniform phase separation was achieved on the membrane surface after ethanol spraying. Nevertheless, several dark spots were observed, possibly due to the collision of ethanol droplets and the resulted nuclei agglomeration of phase inversed polymer chains, which later grew into micro-scale humps. On the other hand, the PLM image of SANIPS-E was opaquer than SANIPS-A, implying a more rapid phase inversion after ethanol spraying. This is because the evaporation of ethanol led to a lower temperature at the membrane surface and facilitated the top skin formation, leaving a shorter time for the polymer crystals to grow. Therefore, SANIPS-E exhibited a less rough coralloidal structure on the nanoscale as compared to SANIPS-A.

Water, however, possesses a high surface tension of 71.99 mN/m at 25° C. due to the strong hydrogen bonding. As a result, the water mist contained larger droplets than those in the ethanol mist. In other words, with the same amount of spraying materials, there were fewer water droplets than ethanol droplets. A comparison of PLM images between SANIPS-E and SANIPS-W confirmed that the phase inversion spots in SANIPS-Wwere much less than SANIPS-E. Moreover, the difference in solubility parameter between water and PVDF was much greater than that between ethanol and PVDF (i.e., 24.6 vs. 3.3. MPa^{½}), which makes water a far stronger non-solvent than ethanol towards PVDF. Thus, when water droplets hit the nascent membrane, a drastic phase separation occurred immediately at the contact points, creating volcano structures as seen in FIGS. 3(d) and 4(d). When the membrane was submerged in a water bath, liquid-liquid demixing took place at the interface between water and the unsolidified polymer solution. As a result, a morphology consisting of volcanos and a relatively less porous skin is formed. Interestingly, among SANIPS-A, SANIPS-E and SANIPS-W, the SANIPS-W membrane had the thinnest wall thickness (FIG. 9). This arose from the fact that the SANIPS-W membrane has the least porous top skin (FIG. 3(d)), which exerted the highest resistance for water intrusion during the liquid-liquid demixing.

Consistent with the trend in the morphology, the SANIPS-W membrane had the highest tensile stress and Young’s modulus among these three SANIPS membranes (FIG. 10) due to its smallest surface porosity and pore size (Table 1), and highly interconnected cross-sectional structures. Although SANIPS-A and SANIPS-E exhibit almost similar porosity, wall thickness (FIG. 9) and cross-sectional structures, the latter has higher tensile stress and Young’s modulus than the former mainly due to the smaller surface porosity and pore size. While membrane distillation operates at mild pressure, membranes with greater mechanical integrities are still highly desirable, because in large-scale applications, a hydraulic pressure must be applied to counterbalance the pressure drop, which can be high when a high flow rate or a long and congested module is used.

FIG. 11 compares LEP of different membranes. Generally, LEP is the applied hydraulic pressure at which water can penetrate through the membrane. It is an important indicator of anti-wetting property for a membrane. Due to the remarkable water repellence (FIG. 2), all the SANIPS membranes exhibited LEP values higher than 2 bar. SANIPS-E even achieved a remarkable LEP of 3.58 bar, outperforming most existing DCMD membranes. SANIPS-E has the highest LEP value because it has (1) the highest water contact angle (FIG. 2), (2) smaller surface porosity and pore size than SANIPS-A (Table 1), (3) unique re-entrant surface structures and spherulitic cross-sectional structure which are essential for robust hydrophobicity. The LEP measurement proves the superior anti-wetting abilities of SANIPS membranes.

### DCMD Tests

The wetting resistance and self-cleaning abilities of NIPS and SANIPS membranes were further tested by treating a feed solution containing 2000 ppm Rose Bengal and 10% NaCl via DCMD. As shown in FIG. 12(a), NIPS experienced a gradual decrease in flux after 1 hour while all the SANIPS membranes maintained stable fluxes throughout the 5-hour tests. Interestingly, despite the significant flux reduction, the rejection of NIPS was still higher than 99.9% throughout the test. That implies the flux decline is mainly ascribed to surface wetting and pore blockage by dye molecules and salt crystals. Thus, the rejection data was not displayed due to their negligible changes throughout the tests. Red stains from Rose Bengal were clearly observed on NIPS, indicating a severe dye adsorption. On the contrary, all the SANIPS membranes remained clean due to their excellent self-cleaning abilities. FIGS. 13(a) and (b) compare the surface morphology between NIPS and SANIPS-W after DCMD tests. Thus, it can be seen that the SANIPS membranes possess superior self-cleaning ability compared to the traditional NIPS membrane.

DCMD tests show that SANIPS-E and SANIPS-W have slightly higher vapour fluxes than SANIPS-A. To further increase the fluxes, the PVDF concentration in the dope solutions was reduced by 3% to prepare SANIPS-LE and SANIPS-LW. As shown in FIGS. 13(c) to 13(f), both membranes exhibit multilevel roughness and remarkable superhydrophobicity. Their fluxes and wetting resistances were then tested in long-term DCMD processes to treat a feed solution containing 2000 ppm Rose Bengal and 10% NaCl at 60° C. (FIG. 12(b)). LE and LW represent membranes prepared by using a lower concentration polymer solution with ethanol and water spraying, respectively. The lower polymer concentration resulted in remarkable average fluxes of 26.5 and 36.0 kg m⁻² h⁻¹ for SANIPS-LE and SANIPS-LW, respectively. The flux of the latter is higher due to the thinner membrane thickness. In addition, both membranes showed stable performances and salt rejections over 99.9% throughout the entire 100-hour tests, demonstrating their great potential in treating high salinity dye wastewater. Consistent with the aforementioned LEP values, SANIPS-LE exhibits less flux fluctuations than SNIAPS-LW.

### Example 2 - Membranes Based on Other Commercial Semi-Crystalline Polymers

To explore the potential of using this SANIPS method for fabricating highly porous membranes with superhydrophobicity and multilevel roughness, PVDF-HFP and PAN membranes were prepared via NIPS and SANIPS methods. Table 5 shows the dope compositions and fabrication conditions for membrane prepared with the polymers.

TABLE 5

Dope compositions and fabrication conditions for membrane prepared by commercial semi-crystalline polymers

| Parameter | NIPS-HFP | SANIPS-HFP-A | SANIPS-HFP-W | NIPS-PAN | SANIPS-PAN-A | SANIPS-PAN-W |
|---|---|---|---|---|---|---|
| Dope concentration (wt. %) | PVDF-HFP/EG/Water/NMP = 14.6/14.6/2.4/68.4 | | | PAN/Water/NMP = 10/7/83 | | |
| Dope temperature (°C) | 60.0±0.5 | | | | | |
| Spray material | - | Compressed air | Water | - | Compressed air | Water |
| Duration In water (h) | 20 | | | | | |

Compressed air and water, instead of ethanol, were employed as spraying materials to minimize the use of organic solvents. As seen in FIG. 14, the SANIPS method significantly increased the surface roughness and porosity, and greatly suppressed the formation of macro-voids, for both PVDF-HFP (FIG. 14(a)) and PAN membranes (FIG. 14(b)). As a result, SANIPS PVDF-HFP membranes exhibited near superhydrophobicity and self-cleaning ability as indicated by their large contact angles and small sliding angles (FIG. 15(a)).

Surprisingly, the spraying treatment pulled down the contact angles of PAN membranes to a near super-hydrophilic level (FIG. 15(b)). This is ascribed to the hydrophilic nature of PAN that favoured a complete wet state (Wenzel state). As predicted by Wenzel’s correlation, cosθ* = rcosθ, where r is the roughness (i.e., the ratio of the total solid surface area to the projected area), the apparent contact angle decreases with the increase of roughness for a hydrophilic surface. Similar to the enhancement in hydrophobicity, improving membrane hydrophilicity is also highly desirable in several membrane applications such as ultrafiltration (UF) and microfiltration (MF) because a high hydrophilicity not only promotes water absorption and transfer but also improves fouling resistance to organic.

### Example 3 - Other Types of Spraying Materials

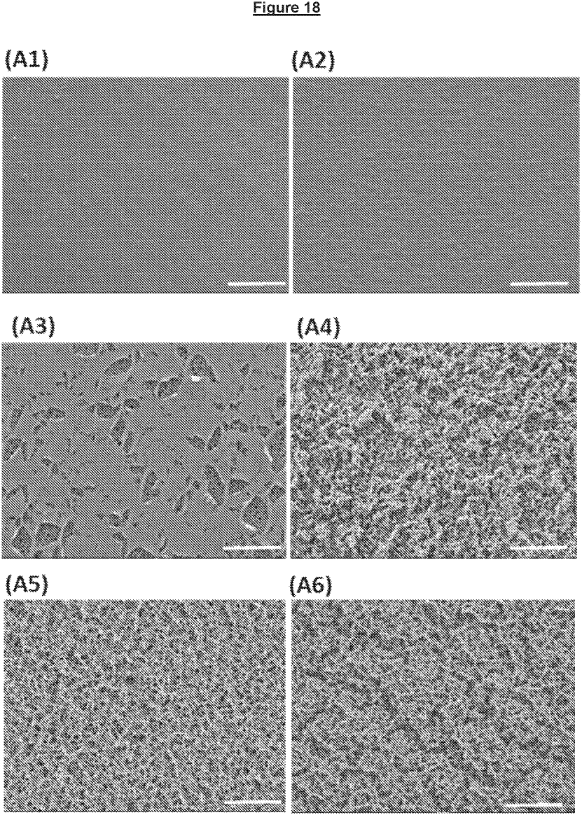

Besides pure fluids, the spraying materials can also be liquid mixtures or solid suspensions. FIGS. 16 and 17 show the FE-SEM images of membranes prepared with spraying materials containing ethanol/water: 50/50 by weight (liquid phase) and ethanol/water/NaCl: 50/36.8/13.2 by weight (solid suspension), respectively. Both membranes exhibit hierarchical surface structures and macrovoid-free cross sections when characterised with FE-SEM.

### Example 4 - Optimisation of Spraying Conditions

The spraying conditions (e.g. spraying duration, ambient humidity, dope temperatures, distance between nozzle and membrane surface and pressure of spraying air, etc.) were optimised to produce a membrane with stronger mechanical properties.

It was found that the humidity level and spraying duration have the most significant impact on the membrane mechanical properties. When the humidity level was too low, it was difficult to induce the moisture condensation during the air spraying stage. Thus, the resultant membrane was not superhydrophobic. Thus, the humidity range was set to be greater than 40%. When the humidity level was fixed, there was an optimal spraying duration that guaranteed a superhydrophobic and self-cleaning membrane surface with good mechanical strength. The conditions for the membrane preparation are as shown in Table 6.

TABLE 6

Membrane preparation conditions

| | | | | | | | | | | | | | |
|---|---|---|---|---|---|---|---|---|---|---|---|---|---|
| Conditions | NIP S | SANIPS -30 s | SANIPS -45 s | SANIPS -60 s | SANIPS -75 s | SANIPS -90 s | SANIPS -60 s-3 bar | SANIPS -60 s-1 bar | SANIPS -60 s-room temp | SANIPS -60 s-10 cm | SANIPS -60 s-5 cm | SANIPS -60 s-30% | SANIPS -60 s-70% |
| Dope composition | PVDF/EG/NMP = 12/10/78 | | | | | | | | | | | | |
| Dope temperature (°C) | 60 | | | | | | | | Room temperature | | | | |
| Relative humidity (%) | 50 | | | | | | | | | | | 30 | 70 |
| Spraying duration (sec) | N.A. | 30 | 45 | 60 | 75 | 90 | 60 | | | | | | |
| Distance (cm) | | 20 | | | | | | | | 10 | 5 | 20 | |
| Air pressure (bar) | | 2 | | | | | 3 | 1 | 2 | | | | |
| Water | 20 hours | | | | | | | | | | | | |

### Membrane Morphology

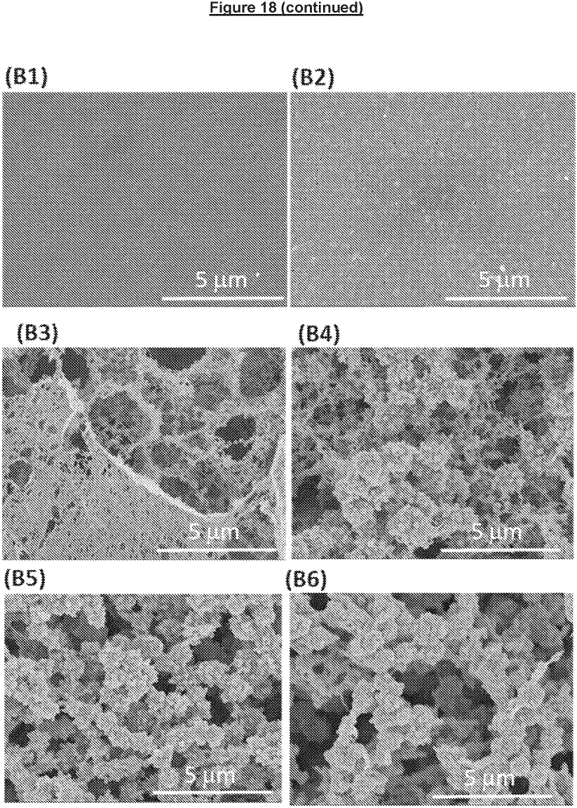

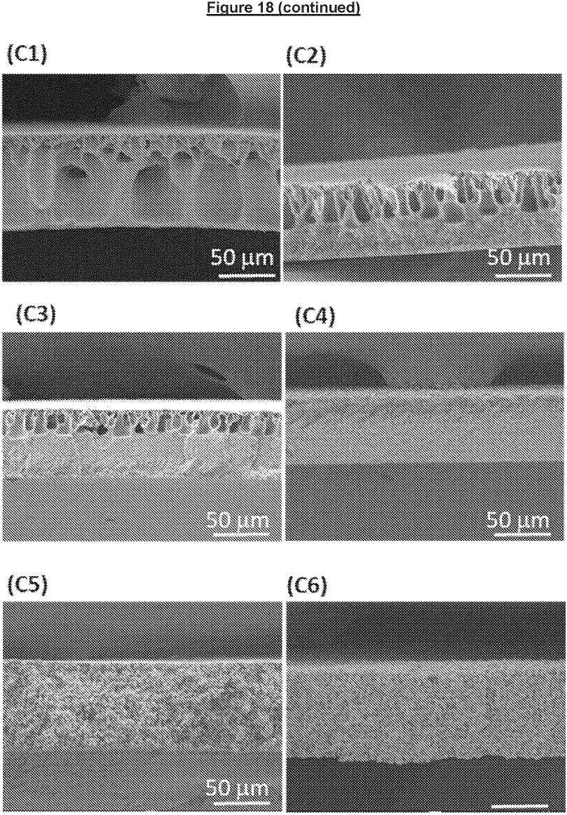

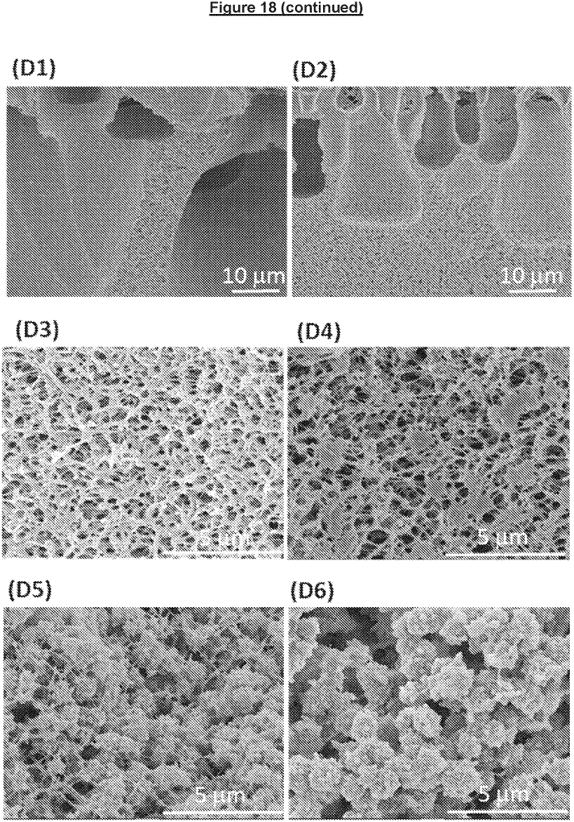

Surface and cross-sectional morphologies of membranes prepared with different air spraying duration are shown in FIG. 18. As expected, the top surface of the NIPS membrane (i.e., 0 s of air spraying) was smooth with no visible open pores while the cross-section was full of finger-like macrovoids. These structures are typical for a NIPS membrane due to the rapid solvent-nonsolvent interchange during the phase inversion process. When air-spraying was introduced to the nascent membrane before being immersed in the water coagulant, manifest changes, which are clearly associated with the spraying duration, were observed to both top surface and cross-sectional structures. Ripple structure appeared with a 30 s air-spraying, which is due to the turbulence induced by the conventional air flow.

As the spraying duration increased to 45 s, cracks in dozens of micrometers emerge on the originally dense surface. At the same time, macrovoids were gradually suppressed as the air-spraying duration increased. With a 60s air-spraying, the dense skin layer completely disappeared, and the membrane surface became fully rough and porous. The cross section, meanwhile, became macrovoid-free. The enlarged surface image shows that PVDF polymer crystals with multilevel particulate structures were formed. Interestingly, the polymer crystals were only formed on the top surface. The cross-section comprised interconnected sponge-like structure. Further increasing the spraying duration caused no obvious change in the top surface structure, and the cross-section also remained macrovoid-free. Nevertheless, a gradual transition from an interconnected sponge-like structure to a non-connected nodular structure was observed for the cross-section.

### Superhydrophobicity and Self-Cleaning Properties

FIG. 19 shows the water contact angles and sliding angles of membranes prepared with different air spraying durations. With 60 s of air spraying, the membrane became superhydrophobic with a remarkable contact angle of 166.0°. Simultaneously, the originally sticky PVDF membrane surface, from which the water droplet did not come off even when it was turned upside down, transformed into a slippery one, as evidenced by the low sliding angle of 20.0°. A low sliding angle renders the membrane self-cleaning. The improvements in the superhydrophobicity and self-cleaning property became insignificant after 60 s of air spraying.

### Mechanical Properties

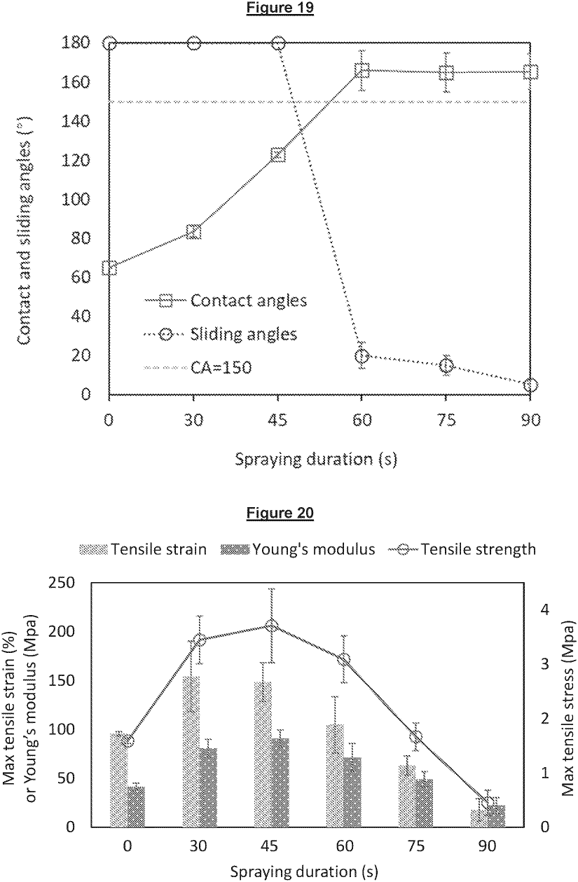

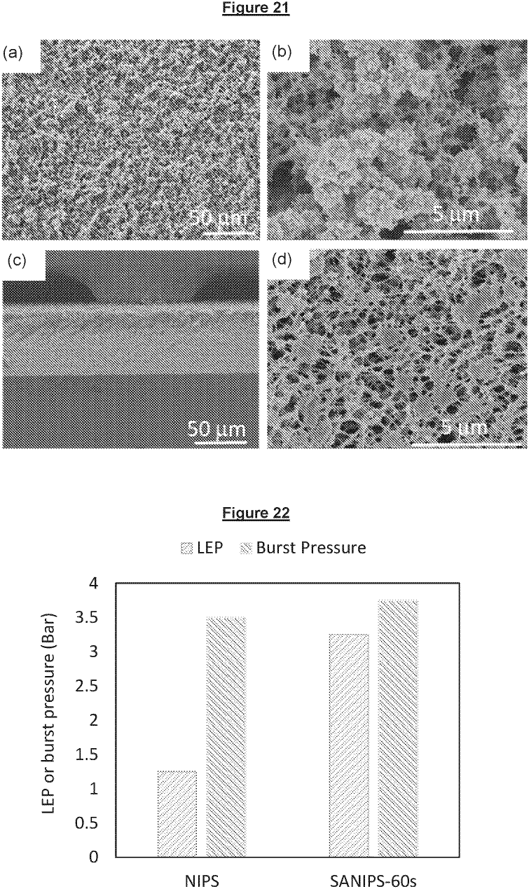

FIG. 20 shows the mechanical properties of the membranes prepared under different spraying durations. Interestingly, the trends of maximum tensile stress, Young’s modulus, and maximum tensile strain are all close to a parabola, with peaks at 45 s or 30 s of air spraying durations. The parabola relationship between the mechanical properties and the spraying duration mainly result from the combined effects of macrovoid formation and polymer crystallinity. The cross-sectional images in FIG. 18 show a gradual elimination of macrovoids as the spraying duration increased from 0 to 60 s. Since macrovoids are commonly regarded as mechanically weak points that sabotage the membrane in long-term operations, the gradual elimination of macrovoids resulted in a continuous improvement in the membrane mechanical strength. On the other hand, microstructure of the membrane cross-section underwent a transition from an interconnected bicontinuous structure to a non-connected spherulite structure. In addition, the growth of polymer crystals was also accompanied by an increase in surface porosity. Consequently, the non-connected membrane structure and increased porosity led to a dramatic decrease in the membrane mechanical integrity. With an optimal air spraying duration of 60 s, a superhydrophobic membrane with a desirable surface structure and an interconnected bicontinuous cross-section structure may be obtained (FIG. 21).

### LEP and Burst Pressure

As seen in FIG. 22, the air-sprayed SANIPS membrane prepared under optimal conditions exhibited remarkable liquid entry pressure and burst pressure, indicating its excellent wetting resistance and robust mechanical stability.

### DCMD Test

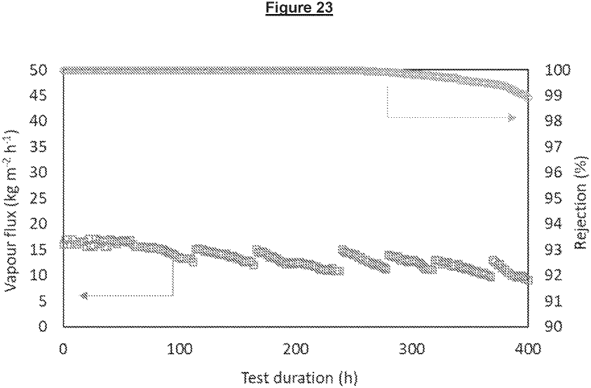

A long-term DCMD test was performed to confirm the long-term stability of the new membrane product. A feed solution consisting of 100 ppm Rose bengal dye and 10% sodium chloride at 60° C. was used. The recovered water was returned to the feed solution intermittently to offset the constant increase in the feed concentration. The long-term test was stopped when the salt rejection dropped below 99.0 %. As seen in FIG. 23, the tested membrane showed stable performance throughout the continuous operation for 400 hours.

The above Examples describe a spray-assisted non-solvent induced phase separation (SANIPS) method to develop superhydrophobic and self-cleaning PVDF membranes with high porosities and tunable multilevel roughness. The spraying step not only induced a rapid partial surface solidification but also causes local distortion of the membrane surface, and thus generates the first level roughness. Subsequently, when the nascent membrane was transferred into water coagulant, the newly formed skin impeded the solvent-nonsolvent exchange and resulted in delayed demixing and the growth of second level roughness. In addition, membrane morphological structures may be tuned by applying different spraying materials. Materials with low surface tensions and solubility parameters such as air and ethanol resulted in hierarchical spherulitic or coralloidal structures. In contrast, water, a strong non-solvent with a high surface tension, facilitated the formation of volcano-like humps on an open network structure.

Without any further surface modification, the SANIPS PVDF membranes exhibited superior repellence toward various types of aqueous solutions and showed remarkable flux (36.0 kg m⁻² h⁻¹), salt rejection (> 99.9%) and long-term stability in treating feed solutions containing 10 wt.% NaCl and 2000 ppm Rose Bengal at 60° C. via DCMD tests. Moreover, it can be seen that the SANIPS method can be readily generalized to other semi-crystalline polymers to significantly amplify their inherent hydrophobicity or hydrophilicity via increasing the surface roughness and porosity.

Whilst the foregoing description has described exemplary embodiments, it will be understood by those skilled in the technology concerned that many variations may be made without departing from the present invention.

1. A porous semi-crystalline polymer membrane, wherein the membrane is a single-layer membrane and wherein the membrane is superwettable without provision of a coating and additives.

2. The membrane according to claim 1, wherein the membrane comprises multilevel roughness within a surface of the membrane.

3. The membrane according to claim 2, wherein the membrane has a surface roughness of 150-900 nm.

4. The membrane according to claim 2, wherein the surface of the membrane has a porosity of ≥ 30%.

5. The membrane according to claim 1, wherein the membrane has an overall porosity of ≥ 80%.

6. The membrane according to claim 1, wherein the membrane has a thickness of 50-250 µm.

7. The membrane according to claim 1, wherein the membrane has a Young’s modulus of ≥ 10 MPa.

8. The membrane according to claim 1, wherein the membrane is superhydrophobic.

9. (canceled)

10. The membrane according to claim 1, wherein the membrane is superhydrophilic.

11. (canceled)

12. The membrane according to claim 1, wherein the membrane has a liquid entry pressure (LEP) of ≥ 2 bar.

13. The membrane according to claim 1, wherein the membrane has a water flux of 10-40 kg/m².h.

14. (canceled)

15. A method of forming a porous semi-crystalline polymer membrane, the method comprising:
depositing a solution on a substrate surface, wherein the solution comprises a semi-crystalline polymer to form a nascent membrane;
spraying a fluid on the nascent membrane; and
immersing the nascent membrane in a non-solvent to form the semi-crystalline polymer membrane,
wherein the semi-crystalline polymer membrane is a single-layer membrane and superwettable without provision of a coating and additives.

16. (canceled)

17. The method according to claim 15, wherein the semi-crystalline polymer comprises a hydrophobic or hydrophilic polymer.

18. (canceled)

19. (canceled)

20. The method according to claim 15, wherein the solution further comprises a solvent and a non-solvent.

21. The method according to claim 15, wherein the depositing comprises depositing the solution at a pre-determined temperature and pre-determined relative humidity.

22. The method according to claim 21, wherein the pre-determined temperature is 20-60° C.

23. The method according to claim 21, wherein the pre-determined relative humidity is ≥ 40%.

24. (canceled)

25. (canceled)

26. The method according to claim 15, wherein the spraying comprises spraying the fluid on the nascent membrane at a pre-determined pressure and at a pre-determined flow rate.

27. The method according to claim 26, wherein the pre-determined pressure is 1-3 bar.

28. (canceled)

29. The method according to claim 15, further comprising drying the membrane following the immersing.
